(19) United States
(12) Patent Application Publication
(10) Pub. No.: US 2015/0090071 A1
(43) Pub. Date: Apr. 2, 2015

(54) CRANK ASSEMBLY OF A SHAFT DRIVEN BICYCLE

(71) Applicant: JEN-CHIH LIU, Kaohsiung City (TW)

(72) Inventor: JEN-CHIH LIU, Kaohsiung City (TW)

(21) Appl. No.: 14/042,745

(22) Filed: Oct. 1, 2013

(51) Int. Cl. B62M 3/00

(52) U.S. Cl. CPC B62M 3/00
USPC 74/594.2

(57) ABSTRACT

A crank assembly of a shaft driven bicycle includes a crank arm pivoted to an axis of a bicycle frame for arranging pedal. The crank arm has at least one main transmission gear to be engaged with a passive gear of a passive shaft. Teeth of the main transmission gear face opposite to the crank arm. The main transmission gear of the crank assembly won't interfere with the axis of the bicycle, and the main transmission gear is driven directly by the crank arms for better power transmission efficiency.

### FIELD OF THE INVENTION

The present invention relates to crank of a shaft driven bicycle, and particular to a crank assembly having a main transmission gear to be engaged by a passive gear of a passive shaft. The main transmission gear has teeth facing opposite to the crank.

### DESCRIPTION OF THE PRIOR ART

Prior transmission mechanism of a bicycle is done by chain connecting to two gears for transmitting power. However chains could cause inconvenient and dangerous situations such as being jammed by cyclist's pants, or fall due to the jam of chain.

Therefore, a shaft driven bicycle is presented to get rid of the chain mechanism. The chain driven mechanism and the shaft driven mechanism is not compatible to each other, both mechanisms need its own frame design to support the mechanism. Known shaft driven mechanisms are designed using a main transmission gear fixed to the axis of the bicycle frame, and the main transmission gear is driven by crank arms pivoted to the axis so that the main transmission gear is rotated with the axis. For the main transmission gear is arranged to the axis of frame, the arrangement of transmission mechanism and overall balance is limited. Moreover, the manufacture cost and assembly for such main transmission gear is higher and complex so that an improvement for the practicability and economic benefit of the product is urgently needed.

### SUMMARY OF THE PRESENT INVENTION

Accordingly, the primary object of the present invention is to provide a crank assembly for a shaft driven bicycle to avoid a limitation of space or designed balance of the bicycle and to efficiently lower the manufacture and assembly cost of the main transmission gear. The main transmission gear driven directly by the crank also provides higher power transmission efficiency so as to improve the practicability and economic benefit of the product.

To achieve above object, the crank assembly of a shaft driven bicycle includes at least one main transmission gear on one crank arm pivoted to the axis of a bicycle frame. The main transmission gear is engaged with a passive gear of a passive shaft. Teeth of the main transmission gear face opposite to the crank arm. Therefore, the crank assembly won't interfere with the axis of the bicycle, and the main transmission gear is driven directly by the crank arms for better power transmission efficiency.

### BRIEF DESCRIPTION OF THE DRAWINGS

FIG. 1 is a cross-section view showing the first embodiment of a main transmission gear of the present invention.

FIG. 2 is a cross-section view showing the second embodiment of the main transmission gear of the present invention.

FIG. 3 is a cross-section view showing the assembly of the first embodiment of present invention.

FIG. 4 is a cross-section view showing the assembly of the second embodiment of present invention

FIG. 5 is a cross-section view showing the assembly of the present invention to a main frame of a bicycle.

FIG. 6 is an enlarged view showing a crank assembly in FIG. 5.

FIG. 7 is a cross-section view showing an embodiment of a sheath of the present invention.

FIG. 8 is a cross-section view showing another embodiment of the sheath of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

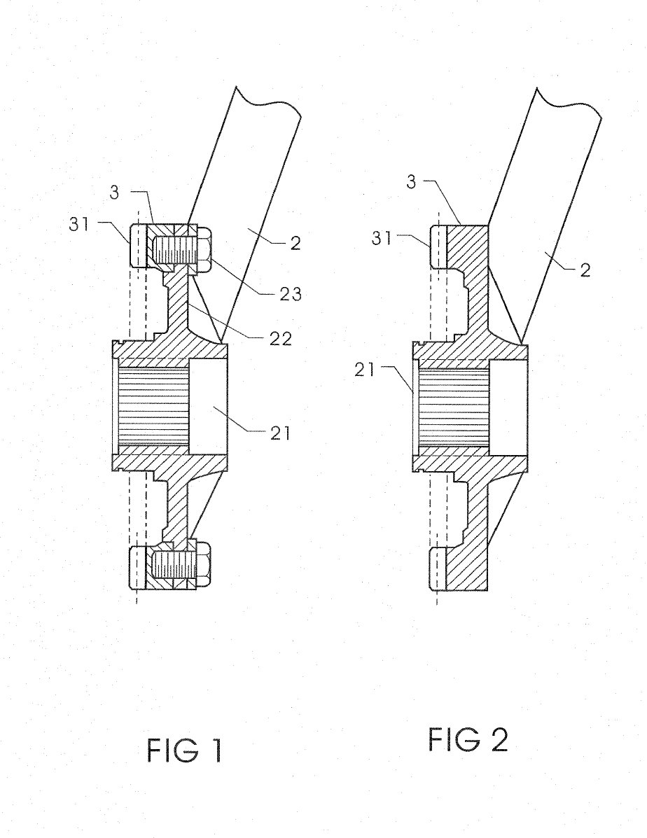

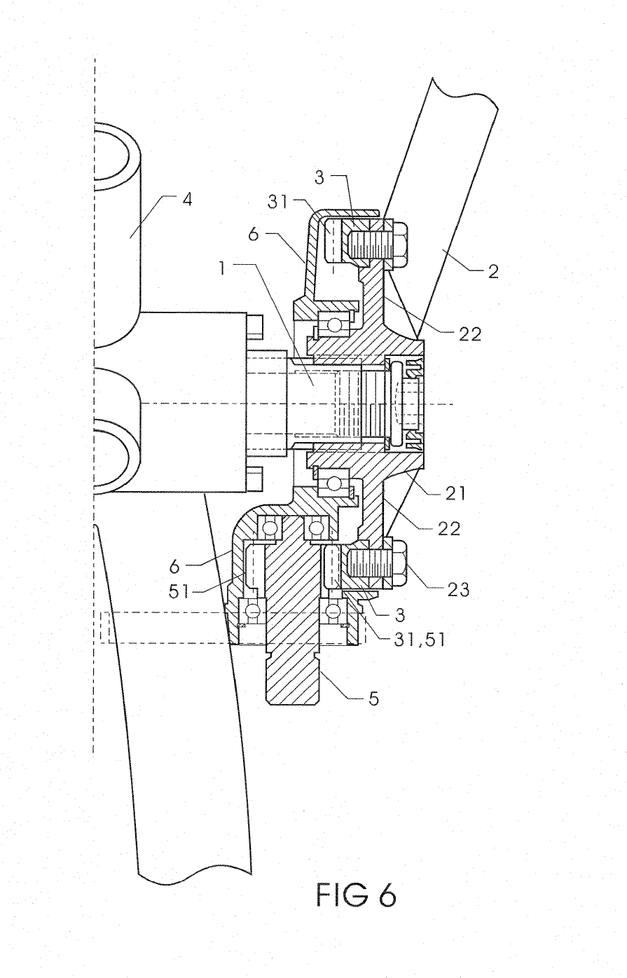

Referring to FIGS. 1 and 2, preferable embodiments of the present invention mainly have at least one main transmission gear 3 on one of crank arms 2 (or an axis sleeve 21 of the crank arm 2) held in axis 1. The main transmission gear 3 is one of a face gear, bevel gear, screw gear, hypoid gear, or other type of gear. In the present embodiment, the main transmission gear 3 is a face gear to be engaged with a passive gear 51 of a passive transmission shaft 5 under a shelter 6 as shown in FIGS. 6 to 8. The teeth 31 of the main transmission gear 3 of the crank arm 2(or axis sleeve 21) face opposite to the crank arm 2.

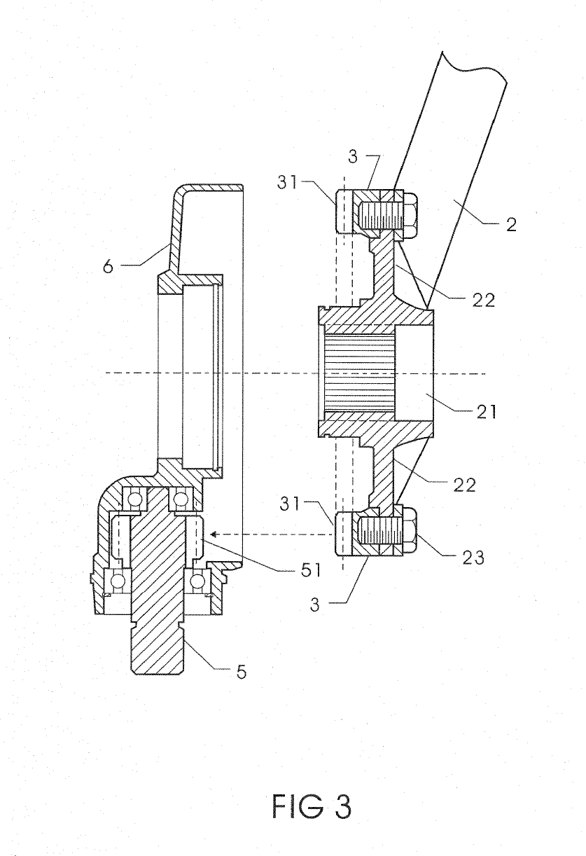

Referring to FIG. 1, the crank arm 2 has an axis sleeve 21 engaging the axis 1. The crank arm 2 has a joint 22 linking between the main transmission gear 3 and the axis sleeve 21, and the ring of the main transmission gear 3 is fixed to the joint 22 by fixing components 23. The teeth 31 of the main transmission gear 3 face opposite to the crank arm 2 so as to transmit cycle to the passive gear 51 of the passive shaft 5 engaged to the main transmission gear 3 under the sheath 6 as shown in FIGS. 3, 5, and 6.

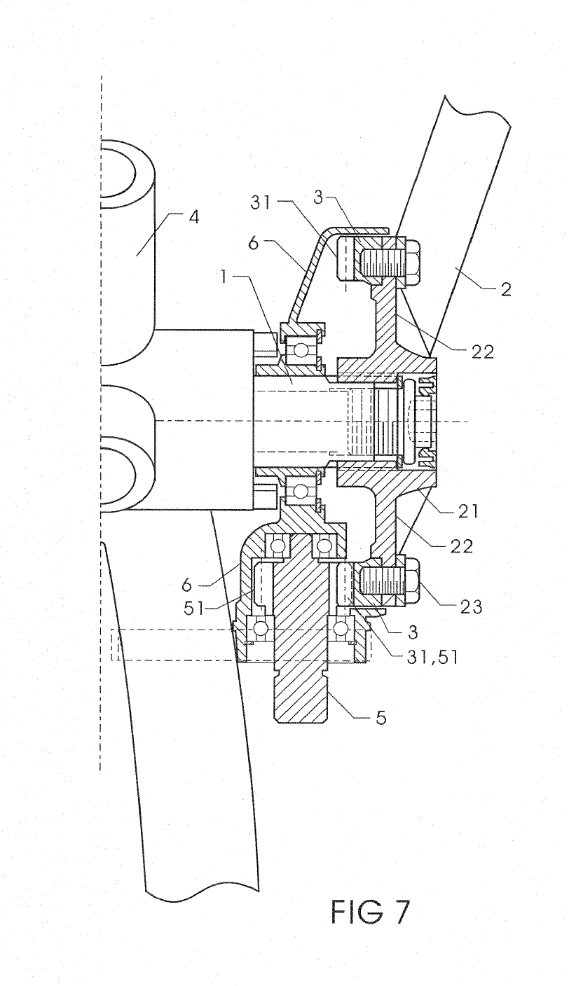

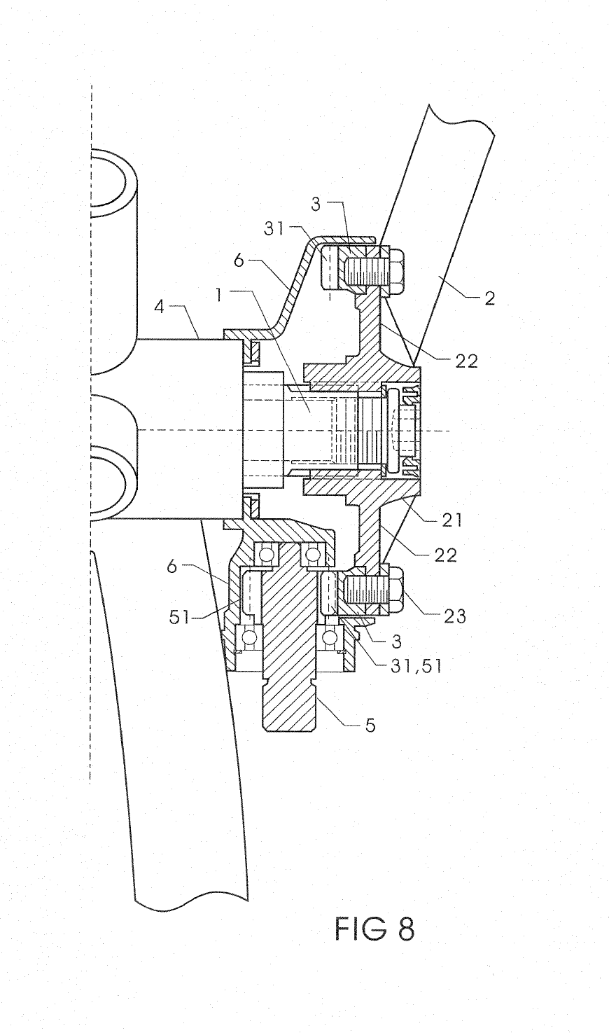

The sheath 6 covering the passive shaft 5 and passive gear 51 is arranged to the crank arm 2 through a central through hole thereof with a bearing arranged therebetween. A predetermined portion of the sheath 6 is fixed to the frame 4 of the bicycle as shown in FIG. 7. The central through hole of the sheath 6 can also be fixed to the frame 4 as shown in FIG. 8 as needed.

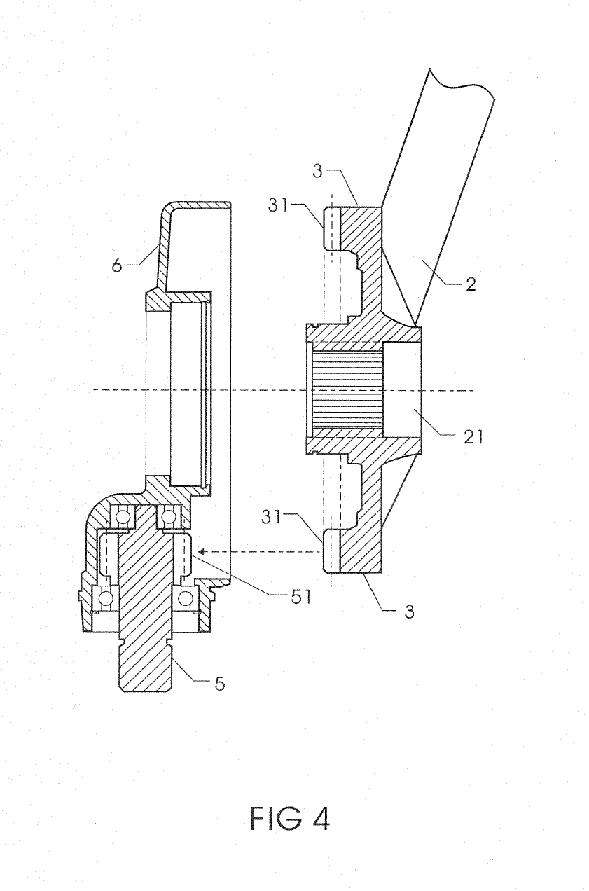

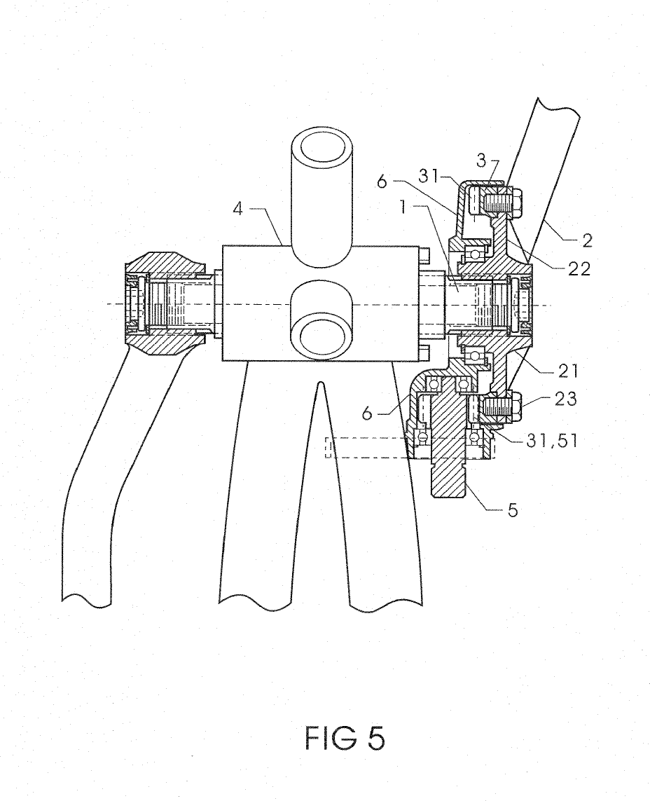

Referring to FIG. 2, another embodiment of the present invention has at least one ring of main transmission gear 3 integrated on the crank arm 2 or a axis sleeve 21 of the crank arm 2. Teeth 31 of the main transmission gear 3 face opposite to the crank arm 2 so as to transmit cycle to passive gear 51 of the passive shaft 5 engaged to the main transmission gear 3 under the sheath 6 as shown in FIG. 4.

Through the above components, the present invention has the following improvements.

1. The assembly of the main transmission gear of a shaft driven bicycle is improved to avoid a limitation of space or designed balance of the bicycle so as to increase practicality of the product.

2. To efficiently lower the manufacture and assembly cost of the main transmission gear so as to increase benefit of the product.

3. The main transmission gear of a shaft driven bicycle can be driven directly by the crank arms for better efficiency and the assembly won't interfere with the axis of the frame of the bicycle.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A crank assembly of a shaft driven bicycle comprising:
a crank arm arranged to an axis of a bicycle frame having at least one main transmission gear; and the main transmission gear having teeth facing opposite to the crank arm;
a passive shaft having a passive gear engaged to the main transmission gear of the crank arm; the passive shaft being covered by a sheath;
wherein the main transmission gear transits cycle of the crank arm to the passive shaft.

2. The crank assembly of a shaft driven bicycle as claimed in claim 1, wherein the crank arm has a joint, and the main transmission gear is fixed to a side of the joint by a fixing component so that the teeth of the main transmission gear face opposite the crank arm.

3. The crank assembly of a shaft driven bicycle as claimed in claim 1, wherein the at least one main transmission gear is integrated with the crank arm, and the teeth of the main transmission gear face opposite to the crank arm.

4. The crank assembly of a shaft driven bicycle as claimed in claim 1, wherein the main transmission gear is one of a face gear, bevel gear, screw gear, hypoid gear, or other type of gear.

5. The crank assembly of a shaft driven bicycle as claimed in claim 2, wherein the crank arm has axis sleeve pivoted to the axis, and the joint of the crank arm is extended from the axis sleeve.

6. The crank assembly of a shaft driven bicycle as claimed in claim 3, wherein the crank arm has an axis sleeve, and the main transmission gear is integrated to the axis sleeve of the crank arm.

7. The crank assembly of a shaft driven bicycle as claimed in claim 1, wherein the passive shaft is arranged to the sheath, and the sheath is arranged to the crank arm with bearings.

8. The crank assembly of a shat driven bicycle as claimed in claim 1, wherein the passive shaft is arranged to the sheath; the sheath has a central through hole, and the sheath is arranged to the axis of the bicycle frame through the central through hole with bearings.

9. The crank assembly of a shaft driven bicycle as claimed in claim 1, wherein the passive shaft is arranged to the sheath; the sheath has a central through hole, and the sheath is arranged to the bicycle frame through the central through hole.
